(19) United States
(12) Patent Application Publication
(10) Pub. No.: US 2009/0100287 A1
(43) Pub. Date: Apr. 16, 2009

(54) Monitoring Apparatus and a Monitoring Method Thereof

(76) Inventors: Shao-Kang Chu, Taipei City (TW); Cheng-Yi Cheng, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/211,942

(22) Filed: Sep. 17, 2008

(30) Foreign Application Priority Data
Oct. 12, 2007 (TW) 096138334

(51) Int. Cl. G06F 11/07

(52) U.S. Cl. 714/2; 714/E11.021

(57) ABSTRACT

A monitoring apparatus and a monitoring method thereof are disclosed. The monitoring apparatus is used to monitor a computer. The monitoring apparatus comprises a control unit, and a first non-volatile memory unit. If the computer has an abnormal operation before loading an operating system, the control unit is used to store an error code according to the abnormal operation in the first non-volatile memory unit and execute a recovery process according to the error code.

### BACKGROUND OF THE INVENTION

1. Field of the Invention

The present invention relates to a monitoring apparatus; more particularly, the present invention relates to a monitoring apparatus and monitoring method thereof for monitoring a condition of a computer and executing a recovery process.

2. Description of the Related Art

Currently, when a computer system is executing a boot process, it always utilizes a basic input/output system (BIOS) code to execute a power-on self test (POST) procedure, so as to perform a basic test to the computer system. However, in order to save boot time, usually the POST procedure only performs simple tests; as a result, possible abnormal operations of the computer system might not be immediately detected during the POST procedure. Generally, if a failure occurs during the boot process, the computer system would be stopped at a certain frame or could not continue the boot process because the computer system does not have a recovery function. If the computer system has an abnormal operation, generally a user could only solve the abnormal operation based on past experience. For example, the user would probably reboot the computer system, or reset the computer system.

Further, if there is a problem during the boot procedure, usually the computer system would remind the user of the problem by means of displaying an error message on a display or issuing an alert tone via a speaker. However, if the problem occurs before the BIOS code activates the display or the speaker, the user would have no way of knowing how the problem occurs.

Therefore, there is a need to provide a monitoring apparatus and a monitoring method thereof to mitigate and/or obviate the aforementioned problems.

### SUMMARY OF THE INVENTION

It is an object of the present invention to provide a monitoring apparatus and a monitoring method thereof, so as to monitor and repair an abnormal operation of a computer.

To achieve the aforementioned object, the present invention firstly provides a monitoring apparatus. The monitoring apparatus is installed on a motherboard of a computer, used for monitoring operations of the computer. The monitoring apparatus comprises a control unit, a first non-volatile memory unit, a second non-volatile memory unit, a switch module and an alert device. The control unit is coupled to an I/O controller of the motherboard. If the computer has an abnormal operation, the control unit stores an error code to the first non-volatile memory unit, and controls the computer to execute a recovery process corresponding to the error code. The second non-volatile memory unit is used for storing a backup BIOS code. The switch module is coupled to the control unit. A user can utilize the switch module to control the control unit to perform an interrupt procedure, so as to interrupt any process of the computer. The alert device is used for displaying the error code or issuing an alert tone corresponding to the error code.

A first preferred embodiment of a monitoring method of the present invention comprises the following steps: determining whether a computer has an abnormal operation before the computer loads an operating system or not; if the computer has the abnormal operation, receiving a diagnostic code; storing an error code according to the abnormal operation; determining whether a BIOS code is damaged or not; if the BIOS code is damaged, executing a backup BIOS code; displaying the error code or issuing an alert tone corresponding to the error code; and executing a recovery process corresponding to the error code.

A second preferred embodiment of the monitoring method of the present invention comprises the following steps: sending an interrupt procedure to perform a system monitor process after a computer loads an operating system; displaying at least one system information of the computer; determining whether the computer has an abnormal operation or not; if the computer has the abnormal operation, storing an error code according to the abnormal operation; displaying the error code or issuing an alert tone corresponding to the error code; and executing a recovery process corresponding to the error code.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustration only, and not as a definition of the invention.

In the drawings, wherein similar reference numerals denote similar elements throughout the several views:

FIG. 1 is a schematic drawing of a computer and its monitoring apparatus of the present invention.

FIG. 2 is a flowchart of a first embodiment of a monitoring method executed by the monitoring apparatus of the present invention.

FIG. 3 is a flowchart of a second embodiment of the monitoring method executed by the monitoring apparatus of the present invention.

### DETAILED DESCRIPTION OF THE PREFERRED EMBODIMENT

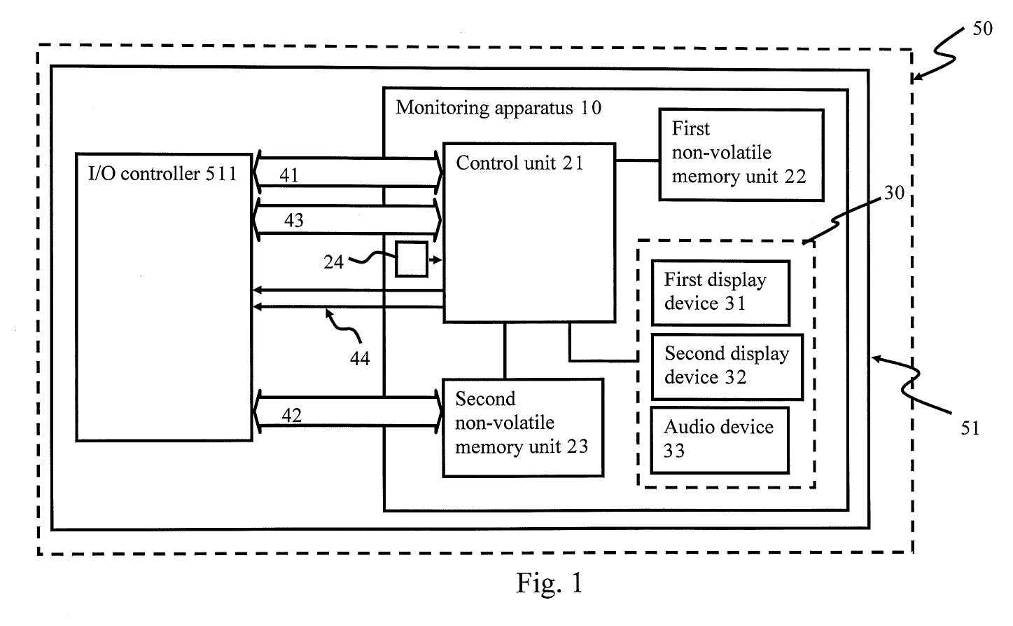

Please refer to FIG. 1, which is a schematic drawing of a computer and its monitoring apparatus of the present invention.

As shown in FIG. 1, the computer 50 of the present invention comprises a motherboard 51. The motherboard 51 is installed with a monitoring apparatus 10, used for monitoring operations of the computer 50. In this embodiment, the monitoring apparatus 10 is implemented as a small card or a module for being selectively installed on the motherboard 51.

In one preferred embodiment of the present invention, the computer 50 can be, but not limited to, a desktop computer. Any other device (such as a laptop computer) which has the structure as shown in FIG. 1 belongs to the scope of the computer 50 in the present invention.

As shown in FIG. 1, the motherboard 51 further comprises an I/O controller 511 coupled to the monitoring apparatus 10. In this embodiment, the I/O controller 511 can be, but not limited to, a south bridge chip of the motherboard 51.

The monitoring apparatus 10 comprises a control unit 21, a first non-volatile memory unit 22, a second non-volatile memory unit 23, a switch module 24 and an alert device 30. In one preferred embodiment of the present invention, the control unit 21 can be, but not limited to, a complex programmable logic device (CPLD) chip. In one preferred embodiment of the present invention, the first non-volatile memory unit 22 can be, but not limited to, a flash memory; and the second non-volatile memory unit 23 can be, but not limited to, a read only memory (ROM).

The control unit 21 can utilize interfaces to couple to the I/O controller 511 for transmitting commands or data. For example, the interfaces can be a low pin count (LPC) interface bus 41, a serial peripheral interface (SPI) bus 42, a system management (SM) bus 43 or a plurality of pins 44.

In one preferred embodiment of the present invention, the control unit 21 utilizes the LPC interface bus 41 to receive a diagnostic code sent by the I/O controller 511, or to transmit a diagnostic command to the I/O controller 511 for monitoring a system condition of the computer 50. If the computer 50 has an abnormal operation, the control unit 21 can also receive a diagnostic code generated by the I/O controller 511. Further, the control unit 21 can receive at least one system information of the computer 50 via the SM bus 43. The system information comprises information such as a temperature, a voltage or a fan speed of the computer 50. The control unit 21 can transmit different commands to the I/O controller 511 via different pins 44, so as to control the computer 50 to execute processes such as a system reset process, a system shutdown process, a system reboot process, or a system suspension. A monitor process of the present invention will be hereinafter described in more detail.

The first non-volatile memory unit 22 is coupled to the control unit 21, and is used for recording an error code if the computer 50 has the abnormal operation. When the computer 50 is under a power-on self test (POST) stage, the I/O controller 511 would generate diagnostic codes, and the I/O controller 511 would keep transmitting the diagnostic codes to the control unit 21 via the LPC interface bus 41. If the abnormal operation is detected, then, according to a received diagnostic code, the control unit 21 would be aware of a diagnostic stage that the I/O controller 511 is executing when the abnormal operation occurs. Therefore, the control unit 21 can receive a corresponding error code according to the diagnostic code, and can store the error code to the first non-volatile memory unit 22. As a result, later on a user or a maintenance staff can be aware of the abnormal operation of the computer 50 after reading the error code stored in the first non-volatile memory unit 22, so as to repair the abnormal operation accordingly. In one preferred embodiment of the present invention, the first non-volatile memory unit 22 can be, but not limited to, a flash memory, so as to prevent the stored error code from being eliminated due to a power on/off procedure of the computer 50.

The second non-volatile memory unit 23 is respectively coupled to the control unit 21 and the I/O controller 511, and is used for storing a backup basic input/output system (BIOS) code. If the computer 50 has the abnormal operation and an original BIOS code is damaged, the backup BIOS code helps the computer 50 to perform a boot procedure and to execute subsequent procedures. In one preferred embodiment of the present invention, the second non-volatile memory unit 23 is, but not limited to, a read only memory (ROM), so as to prevent the stored backup BIOS code from being altered due to a man-made or virus factor. The second non-volatile memory unit 23 can utilize the LPC interface bus 41 or the SPI bus 42 to couple to the I/O controller 511 of the motherboard 51. For example, in FIG. 1, the second non-volatile memory unit 23 utilizes the SPI bus 42 to couple to the I/O controller 511, such that the computer 50 can execute the backup BIOS code via the I/O controller 511 and the SPI bus 42.

The switch module 24 is coupled to the control unit 21. The user can utilize the switch module 24 to control the control unit 21 to send an interrupt procedure, so as to interrupt any ongoing process of the computer 50, thereby facilitating a system monitor process.

The alert device 30 is coupled to the control unit 21. If the computer 50 has the abnormal operation, the alert device 30 is used for displaying the error code or issuing an alert tone corresponding to the error code. In one preferred embodiment of the present invention, the alert device 30 comprises a first display device 31, a second display device 32 and an audio device 33. The first display device 31 is disposed to the monitoring apparatus 10 for displaying the error code; the second display device 32 can be coupled to the control unit 21 via a cable, and the second display device 32 is preferably disposed to a front panel of the computer 50, such that the user can be aware of the error code and the system information of the computer 50 in an easier and more convenient way.

In one preferred embodiment of the present invention, the first display device 31 and the second display device 32 can be, but not limited to, a seven-segment display or a liquid crystal display. A seven-segment display can display 16 symbols including 0˜9 and A˜F. Therefore, 256 (or more) symbols can be displayed by means of combining two (or more) seven-segment displays. A liquid crystal display can display comparatively more complete information. The audio device 33 can be a speaker or a buzzer, so as to issue a tone to remind the user of the abnormal operation or system information of the computer 50. Accordingly, the user or the maintenance staff can be aware of the abnormal operation of the computer 50.

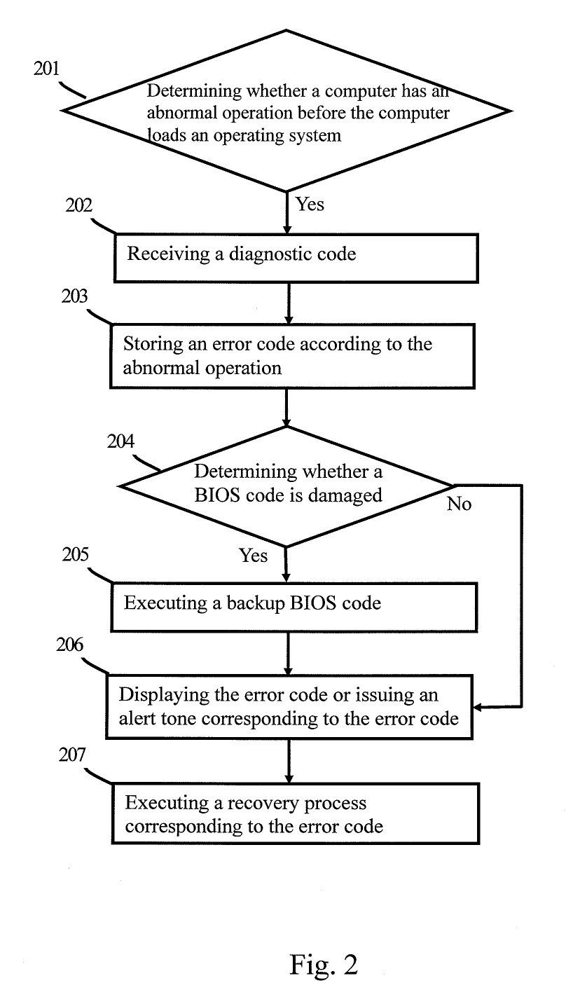

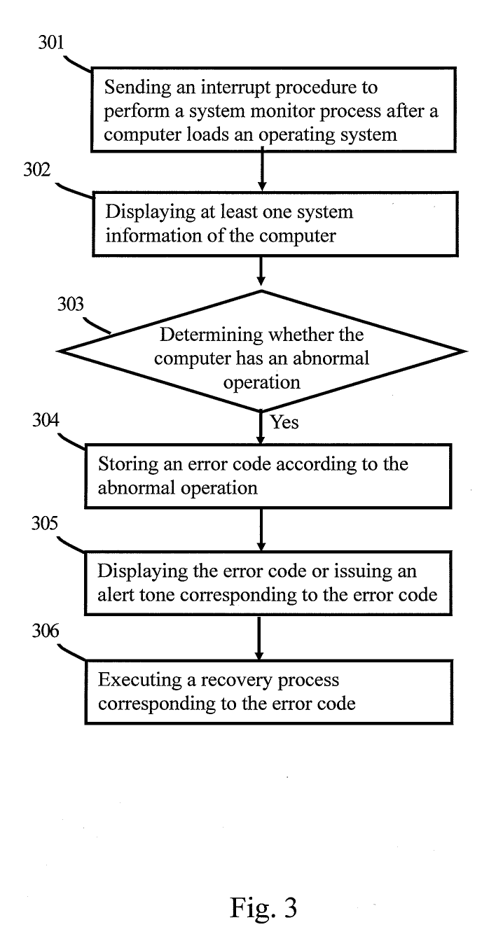

Please refer to FIG. 2 and FIG. 3, which are flowcharts of the monitoring method executed by the monitoring apparatus of the present invention. Please note that the monitoring method of the present invention is not limited to be used in the monitoring apparatus 10. FIG. 2 is a flowchart of a first embodiment of a monitoring method executed by the monitoring apparatus of the present invention. FIG. 3 is a flowchart of a second embodiment of the monitoring method executed by the monitoring apparatus of the present invention.

FIG. 2 is a flowchart of a first embodiment of a monitoring method executed by the monitoring apparatus of the present invention. The first embodiment of the present invention describes a monitoring method executed by the monitoring apparatus 10 before the computer 50 loads an operating system.

At first, the present invention performs step 201: determining whether a computer has an abnormal operation before the computer loads an operating system.

When the computer 50 executes a boot process, the I/O controller 511 executes a power-on self test (POST) procedure based on a BIOS code before the computer 50 loads the operating system. When the I/O controller 511 performs the test, the I/O controller 511 would keep transmitting diagnostic codes to the control unit 21 via the LPC interface bus 41. If the computer 50 has the abnormal operation, the present invention then performs step 202.

Step 202: receiving a diagnostic code.

Because the I/O controller 511 keeps transmitting the diagnostic codes to the control unit 21, then, if the I/O controller 511 detects the abnormal operation, the control unit 21 would receive a corresponding diagnostic code when the abnormal operation occurs, so as to be aware of a diagnostic stage that the I/O controller 511 is executing.

Further, because the I/O controller 511 does not perform a complete diagnostic test when the system is performing the boot process, the control unit 21 can also execute a detailed test, so as to precisely determine in which stage the abnormal operation occurs during the POST procedure. The control unit 21 can send a request for the detailed test to the I/O controller 511 via the LPC interface bus 41, so as to check what the diagnostic code is when the abnormal operation occurs. For example, there are five different stages D1˜D5 during the POST procedure, if the abnormal operation occurs at the D4 stage, the control unit 21 can send a request for rechecking the D4 stage, or for performing a detailed test from the D3 stage. As a result, the control unit 21 can be aware of the diagnostic code when the abnormal operation occurs.

After performing step 202, the present invention then performs step 203: storing an error code according to the abnormal operation.

In step 203, the control unit 21 can receive a corresponding error code according to the diagnostic code when the abnormal operation occurs, and store the error code to the first non-volatile memory unit 22, such that the user or the maintenance staff can check it later on.

The present invention then performs step 204: determining whether a BIOS code is damaged.

Then, the control unit 21 checks whether the BIOS code is damaged. If the BIOS code is damaged, the present invention performs steps 205 and 206; if the BIOS code is not damaged, the present invention directly performs step 206.

Step 205: executing a backup BIOS code.

If the BIOS code is damaged, in step 205, the control unit 21 controls the computer 50 to read the backup BIOS code via the SPI bus 42 to perform the boot process, so as to replace the damaged BIOS code.

In one preferred embodiment of the present invention, one of the implementations for processing the damaged BIOS code is to copy the backup BIOS code into the BIOS code, so as to repair the BIOS code. But please note that the implementations of the present invention are not limited to the above description.

Step 206: displaying the error code or issuing an alert tone corresponding to the error code.

If the determination result of step 204 is that the BIOS code is not damaged, or if step 205 has been performed, the present invention then performs step 206. The control unit 21 controls the alert device 30 to display the error code or issue an alert tone corresponding to the error code. In one preferred embodiment of the present invention, the error code can be displayed via the first display device 31 or the second display device 32 of the alert device 30; or, the alert tone corresponding to the error code can be issued via the audio device 33 to display abnormal information. But please note that the implementations of the present invention are not limited to the above description.

Finally, the present invention performs step 207: executing a recovery process corresponding to the error code.

In step 207, the control unit 21 executes a corresponding recovery process in response to the error code according to different error codes. In one preferred embodiment of the present invention, the recovery process comprises, but not limited to, a system reset process, a system shutdown process, a system reboot process or a system suspension of the computer 50.

According to the above steps, when the computer 50 is performing the boot process, the monitoring apparatus 10 can detect the factor of the abnormal operation before the computer 50 loads the operating system, and can execute an urgent recovery process.

FIG. 3 is a flowchart of a second embodiment of the monitoring method executed by the monitoring apparatus of the present invention. The second embodiment of the present invention describes a monitoring method executed by the monitoring apparatus 10 after the computer 50 loads an operating system.

At first, the present invention performs step 301: sending an interrupt procedure to perform a system monitor process after a computer loads an operating system.

After the computer 50 loads the operating system, the user can control the activation of the monitoring apparatus 10 via the switch module 24. When the user wants to check a system status of the computer 50, the user can utilize the switch module 24 to activate the monitoring apparatus 10. At this time, the control unit 21 sends a signal of the interrupt procedure to the computer 50. For example, the present invention utilizes interrupt control methods such as system management interrupt (SMI) or system control interrupt (SCI) to request for a control right of the computer 50.

Then, the present invention performs step 302: displaying at least one system information of the computer.

In step 302, the control unit 21 receives at least one system information, such as a temperature, a voltage or a fan speed, of the computer 50 via the SM bus 43. Further, the present invention can utilize the first display device 31 or the second display device 32 of the alert device 30 to display the error code; or the present invention can utilize the audio device 33 to issue an alert tone corresponding to the error code, so as to remind the user of the current system information of the computer 50.

Then, the present invention performs step 303: determining whether the computer has an abnormal operation.

At this time, the control unit 21 sends a signal via the LPC interface bus 41, such that the I/O controller 511 can perform a diagnostic process to the computer 50, and return a diagnostic code to the control unit 21 via the LPC interface bus 41. If the computer 50 has the abnormal operation, the present invention then performs step 304.

Step 304: storing an error code according to the abnormal operation.

In step 304, the control unit 21 receives a corresponding error code according to the diagnostic code when the abnormal operation occurs, and stores the error code to the first non-volatile memory unit 22, such that the user or the maintenance staff can check it later on.

Then, the present invention performs step 305: displaying the error code or issuing an alert tone corresponding to the error code.

Then, the control unit 21 controls the alert device 30 to send a signal according to the error code. In one preferred embodiment of the present invention, the error code can be displayed by the first display device 31 or the second display device 32 of the alert device 30; or, the alert tone corresponding to the error code can be issued by the audio device 33 to display abnormal information. But please note that the implementations of the present invention are not limited to the above description.

Then, the present invention performs step 306: executing a recovery process corresponding to the error code.

In step 306, the control unit 21 executes a corresponding recovery process in response to the error code according to different error codes. In one preferred embodiment of the present invention, the recovery process comprises, but not limited to, a system reset process, a system shutdown process, a system reboot process or a system suspension of the computer 50.

According to the above steps, the monitoring apparatus 10 can detect if an abnormal operation occurs after the computer 50 performs the boot process and loads the operating system, and can execute an urgent recovery process.

Please note that the order of steps of the monitoring method of the present invention is not limited to the above description. The order of the above steps can be adjusted in order to achieve the object of the present invention.

According to the monitoring apparatus 10 and the monitoring method of the present invention, the monitor process can be executed before or after the computer 50 loads the operating system. And, the present invention can execute a recovery process corresponding to an error code when an abnormal operation occurs. If the monitoring apparatus 10 can not resolve the abnormal operation of the computer 50, the user or the maintenance staff can read the error code stored in the first non-volatile memory unit 22 to be aware of the factor of the abnormal operation, and can accordingly repair the abnormal operation. Further, according to the monitoring apparatus 10 and the monitoring method of the present invention, the computer 50 does not need any additional software or terminate & stay resident (TSR) program, so as to save system resources.

Although the present invention has been explained in relation to its preferred embodiments, it is to be understood that many other possible modifications and variations can be made without departing from the spirit and scope of the invention as hereinafter claimed.

What is claimed is:

1. An apparatus, installed on a motherboard of a computer for monitoring operations of the computer, the apparatus comprising:
a first non-volatile memory unit; and
a control unit, coupled to the first non-volatile memory unit, wherein the control unit is used to store an error code to the first non-volatile memory unit, and to control the computer to execute a recovery process corresponding to the error code if the computer has an abnormal operation before the computer loads an operating system.

2. The apparatus as claimed in claim 1, wherein the motherboard further comprises an I/O controller coupled to the apparatus, if the computer has the abnormal operation, the control unit receives a diagnostic code generated by the I/O controller, wherein the diagnostic code corresponds to the error code.

3. The apparatus as claimed in claim 2 further comprising a second non-volatile memory unit, respectively coupled to the control unit and the I/O controller, used for storing a backup BIOS code, wherein the control unit helps the computer to perform a boot process through the backup BIOS code if the computer has the abnormal operation.

4. The apparatus as claimed in claim 1 further comprising an alert device coupled to the control unit, wherein the alert device displays the error code or issues an alert tone corresponding to the error code if the computer has the abnormal operation.

5. The monitoring apparatus as claimed in claim 4, wherein the control unit sends an interrupt procedure to perform a system monitor process after the computer loads the operating system, whereby the alert device displays at least one system information.

6. The monitoring apparatus as claimed in claim 5 further comprising a switch module, coupled to the control unit, used for controlling the control unit to send the interrupt procedure to the computer.

7. The apparatus as claimed in claim 1, wherein the recovery process comprises: a system reset process, a system shutdown process, a system reboot process, or a system suspension.

8. A monitoring method, applied to a computer, the monitoring method comprising:
determining whether the computer has an abnormal operation before the computer loads an operating system; and
if the computer has the abnormal operation, storing an error code to a first non-volatile memory unit according to the abnormal operation, and executing a recovery process corresponding to the error code.

9. The monitoring method as claimed in claim 8 further comprising the following step:
if the computer has the abnormal operation, receiving a diagnostic code, wherein the diagnostic code corresponds to the error code.

10. The monitoring method as claimed in claim 8 further comprising the following step:
storing a backup BIOS code, and helping the computer to perform a boot process through the backup BIOS code if the computer has the abnormal operation.

11. The monitoring method as claimed in claim 8 further comprising the following step:
if the computer has the abnormal operation, displaying the error code or issuing an alert tone corresponding to the error code.

12. The monitoring method as claimed in claim 8 further comprising the following step:
sending an interrupt procedure to perform a system monitor process after the computer loads the operating system, and displaying at least one system information of the computer.

13. The monitoring method as claimed in claim 8, wherein the recovery process performs the following steps: executing a system reset process;
executing a system shutdown process; executing a system reboot process; or
suspending a system execution.

14. A computer, comprising:
a motherboard; and
a monitoring apparatus, installed on the motherboard, the monitoring apparatus comprising:
a first non-volatile memory unit; and
a control unit, coupled to the first non-volatile memory unit, wherein the control unit is used to store an error code to the first non-volatile memory unit, and to control the computer to execute a recovery process corresponding to the error code if the computer has an abnormal operation before the computer loads an operating system.

15. The computer as claimed in claim 14, wherein the motherboard further comprises an I/O controller coupled to the monitoring apparatus, if the computer has the abnormal operation, the control unit receives a diagnostic code generated by the I/O controller, wherein the diagnostic code corresponds to the error code.

16. The computer as claimed in claim 15 further comprising a second non-volatile memory unit, respectively coupled to the control unit and the I/O controller, used for storing a backup BIOS code, wherein the control unit helps the computer to perform a boot process through the backup BIOS code if the computer has the abnormal operation.

17. The computer as claimed in claim 14 further comprising an alert device coupled to the control unit, wherein the alert device displays the error code or issues an alert tone corresponding to the error code if the computer has the abnormal operation.

18. The computer as claimed in claim 17, wherein the control unit sends an interrupt procedure to perform a system monitor process after the computer loads the operating system, whereby the alert device displays at least one system information.

19. The computer as claimed in claim 18 further comprising a switch module, coupled to the control unit, used for controlling the control unit to send the interrupt procedure to the computer.

20. The computer as claimed in claim 14, wherein the recovery process comprises: a system reset process, a system shutdown process, a system reboot process, or a system suspension.
